(19) United States
(12) Patent Application Publication
(10) Pub. No.: US 2025/0310814 A1
(43) Pub. Date: Oct. 2, 2025

(54) SYSTEMS AND METHODS FOR EVENT-TRIGGERED OPERATION IN BEAM-BASED COMMUNICATION

(71) Applicant: Huawei Technologies Co., Ltd., Shenzhen (CN)

(72) Inventors: Mostafa Medra, Ottawa (CA); Mohammadhadi Baligh, Ottawa (CA); Xi Zhang, Beijing (CN)

(21) Appl. No.: 19/228,515

(22) Filed: Jun. 4, 2025

Related U.S. Application Data
(63) Continuation of application No. PCT/CN2022/136556, filed on Dec. 5, 2022.

(51) Int. Cl. H04W 24/10; H04W 72/044

(52) U.S. Cl. CPC H04W 24/10; H04W 72/046

(57) ABSTRACT

Aspects of the present disclosure provide methods, apparatuses and devices for event-triggered operation in beam-based communications. A device may transmit, to an apparatus, event triggering information indicative of one or more conditions that when satisfied trigger the apparatus to perform a certain action such as beam measurement and/or beam measurement reporting. The event triggering information may be configured by the device and specific to the apparatus. The apparatus may obtain sensing information related to the event triggering information and/or beam measurement information related to the event triggering information. The apparatus may determine whether the one or more conditions are satisfied based on the event triggering information and/or the sensing information. The apparatus may perform the action when the one or more conditions are satisfied.

### CROSS REFERENCE TO RELATED APPLICATIONS

The present application is a continuation of International Application No. PCT/CN2022/136556, filed on Dec. 5, 2022, the disclosure of which is hereby incorporated by reference in its entirety.

### TECHNICAL FIELD

The present disclosure relates generally to wireless communications, and in particular to methods, apparatuses, and devices for event-triggered operation in beam-based communications.

### BACKGROUND

Existing wireless networks, in particular in networks operating in low frequencies such as Third Generation (3G) and Fourth Generation (4G) long-term evolution (LTE), have heavily relied on reference signal received power (RSRP) measurements at apparatuses and/or devices (e.g., user equipment (UE)) with respect to various operations at those apparatuses and/or devices. Such operations include, but are not limited to, cell association between mobile UEs and serving base stations, determination of modulation coding scheme (MCS), and/or handover (HO) from a current cell to another.

Networks operating in higher frequencies using beam-based communication have followed the footsteps of older generation networks and relied on the beam measurements. For example, in Fifth Generation (5G) New Radio (NR), UEs transmit, to one or more base stations, beam measurement reports associated with a serving beam and other beams that may be used for beam switching, beam failure recovery (BFR) or HO.

Beam measurement is important for data transmission and decoding, as well as beam and cell association, because communication parameters may be configured based at least partly on the beam measurement values. Conventionally, UEs periodically report, to one or more associated base stations, the beam measurement values, for example the measured beam RSRP, signal to noise ratio (SNR), signal to interference and noise ratio (SINR), reference signal received quality (RSRQ), or signal power, or combinations thereof.

Different beam management methods rely on the measured beam RSRP, for example to determine a method to use for beam measurement. In this regard, overhead derived from the beam RSRP measurements and reporting should be carefully considered. While too few measurements and reporting may result in errors, too many measurements and reporting may result in huge overhead in the network and therefore there may be a decrease in available resources for communications between UEs and base stations.

In 5G NR, many UEs rely on more than one beam for communications. Accordingly, one or more beam measurements are needed for performing each beam RSRP reporting. As there may be a number of beams to measure and report, the overall transmission overhead may be quite large. The transmission overhead may become even larger where there are high mobility UEs and high dimensional multi-input multi-output (MIMO) transmissions.

### SUMMARY

As noted above, beam measurements and reporting (e.g., RSRP reporting by a UE) in beam-based communications may result in large overhead that is less efficient in terms of time and resources. Frequent beam measurements and reporting by a UE may also cause large energy consumption.

There have been attempts to reduce large transmission overhead that rely on correlation between the beam measurements and time, frequency, space, and UEs. One example is UE grouping and coordination for beam RSRP reporting. However, such a method considers a group of UEs as one entity, but does not effectively reduce the transmission overhead caused by frequent beam measurements and reporting. Other existing attempts to reduce overhead also do not resolve large transmission overhead caused by frequent beam measurements and reporting.

Therefore, there is a need for a new method which may configure a UE with specific event triggering information defining when or how, or both when and how, the UE may perform a specified action, such as beam RSRP measurement and reporting.

Aspects of the present disclosure provide methods, apparatuses and devices to overcome the shortcomings and limitations described above, as well as specific methods, apparatuses and devices for event-triggered operation in beam-based communication. The specific methods for event-triggered operation in beam-based communication may allow apparatuses and/or devices being triggered to perform an action when one or more conditions triggering a certain event are satisfied. A device (e.g., base station) may configure or determine event triggering information indicative of the one or more conditions for a specific apparatus or specific apparatuses (e.g., UE) such that the event triggering information may be customized or tailored to the specific apparatuses. The apparatus-specific event triggering information may be configured or determined based on sensing information of the apparatus. Due to the apparatus-specific nature of the event triggering information, different apparatuses may be triggered to perform actions based on different conditions or events. For example, given that each apparatus may communicate with a serving base station, an apparatus may perform a beam measurement when a certain condition is satisfied, and another apparatus may perform a beam measurement when another condition is satisfied. The action performed by the apparatus may include, but is not limited to beam measurement, beam measurement reporting, and other actions related to beam measurement and reporting. As the apparatus may perform one or more actions only when one or more apparatus-specific conditions are satisfied, reduced energy consumption and lowered transmission overhead for beam-based communications may be achieved.

According to an aspect of the disclosure there is provided a method for event-triggered operation in beam-based communication involving receiving, by an apparatus from a device, event triggering information indicative of one or more conditions that when satisfied trigger the apparatus to perform an action. The method may further include obtaining, by the apparatus, either sensing information related to the event triggering information or sensing information related to the event triggering information and beam measurement information related to the event triggering information. The method may further include determining, by the apparatus, whether the one or more conditions are satisfied based on the event triggering information and either the sensing information or the sensing information and the beam measurement information. When the one or more conditions are satisfied, the method may further include performing, by the apparatus, the action.

In one possible implement, the obtaining, by the apparatus, either sensing information related to the event triggering information or sensing information related to the event triggering information and beam measurement information related to the event triggering information comprises:
obtaining, by the apparatus, sensing information related to the event triggering information; or
obtaining sensing information related to the event triggering information and beam measurement information related to the event triggering information.

In some embodiments, the event triggering information may be specific to the apparatus.

In some embodiments, the method may further include transmitting, by the apparatus to the device, information indicative of capability of the apparatus in relation to obtaining at least one of the sensing information or the beam measurement information.

In some embodiments, the method may further include transmitting, by the apparatus to the device, an indication that the apparatus is going to perform the action. The method may further include receiving, by the apparatus from the device, at least one of an acknowledgement message or configuration information related to performing the action.

In some embodiments, the event triggering information may include information indicative of at least one of: a condition associated with a measured reference signal received power (RSRP) of a beam, a condition based on the sensing information, or a condition based on a change in the sensing information. In some embodiments, the condition associated with the measured RSRP of the beam may include a measured RSRP of a serving beam being less than a measured RSRP of another beam by a predetermined value. In some embodiments, the condition based on the sensing information or the condition based on the change in sensing information may include at least one of: displacement of a reflector, movement of the apparatus in a specific direction or outside of a specific angular range, or speed of the apparatus being faster than a threshold speed.

In some embodiments, the action may include at least one of: performing beam RSRP measurement, transmitting a beam measurement report, performing beam switching, or adding a beam to a set of beams to be used in a beam failure recovery procedure. In some embodiments, performing beam RSRP measurement may comprise measuring one or more beams transmitted by the device or a different device. In some embodiments, the beam measurement report may be transmitted to the device via a media access control-control element (MAC-CE) carried over physical uplink shared channel (PUSCH) or an uplink control information (UCI) carried over PUSCH or physical uplink control channel (PUCCH).

In some embodiments, the apparatus may determine whether the one or more conditions are satisfied based on one or more preconfigured thresholds to compare with at least one of the sensing information or the beam measurement information.

In some embodiments, the sensing information may include at least one of: location of the apparatus, speed of the apparatus, velocity of the apparatus, acceleration of the apparatus, rotation of the apparatus, orientation of the apparatus, information obtained from a proximity sensor of the apparatus, information obtained from a gyroscope sensor of the apparatus, information related to reflector detection, or information related to blockage detection.

In some embodiments, the beam measurement information may be information related to a measured beam including at least one of: a RSRP of the measured beam, a reference signal received quality (RSRQ) of the measured beam, a signal-to-noise ratio (SNR) of the measured beam, a signal-to-interference-and-noise ratio (SINR) of the measured beam, interference power of the measured beam, or power of the measured beam.

In some embodiments, the apparatus may obtain at least one of the sensing information or the beam measurement information periodically.

In some embodiments, the apparatus may be a user equipment (UE). However, it should be noted that the apparatus may be other type of device such as but not limited to an access point (AP), and a transmit receive point (TRP).

According to an aspect of the disclosure there is provided an apparatus for event-triggered operation in beam-based communication including a processor and a computer-readable medium. The computer-readable medium has stored thereon computer executable instructions that when executed cause the processor to perform a method consistent with the embodiment described above. Examples of different types of the apparatus include but not limited to a user equipment (UE), a base station (BS), an access point (AP), and a transmit receive point (TRP).

According to an aspect of the disclosure there is provided a method for event-triggered operation in beam-based communication involving transmitting, by a device to an apparatus, event triggering information indicative of one or more conditions that when satisfied trigger the apparatus to perform an action, wherein the action is performed by the apparatus when the one or more conditions are satisfied based on the event triggering information and either sensing information related to the event triggering information or sensing information related to the event triggering information and beam measurement information related to the event triggering information.

In some embodiments, the method may further include determining, by the device, the event triggering information.

In some embodiments, the event triggering information may be specific to the apparatus.

In some embodiments, the method may further include receiving, by the device from the apparatus, information indicative of capability of the apparatus in relation to obtaining at least one of the sensing information or the beam measurement information.

In some embodiments, the method may further include receiving, by the device from the apparatus, an indication that the apparatus is going to perform the action. The method may further include transmitting, by the device to the apparatus, at least one of an acknowledgement message or configuration information related to performing the action.

In some embodiments, the event triggering information may include information indicative of at least one of: a condition associated with a measured reference signal received power (RSRP) of a beam, a condition based on the sensing information, or a condition based on a change in the sensing information. In some embodiments, the condition associated with the measured RSRP of the beam may include a measured RSRP of a serving beam being less than a measured RSRP of another beam by a predetermined value. In some embodiments, the condition based on the sensing information or the condition based on the change in sensing information may include at least one of: displacement of a reflector, movement of the apparatus in a specific direction or outside of a specific angular range, or speed of the apparatus being faster than a threshold speed.

In some embodiments, the method may further include transmitting, by the device to the apparatus, one or more beams to be measured by the apparatus.

In some embodiments, the sensing information includes at least one of: location of the apparatus, speed of the apparatus, velocity of the apparatus, acceleration of the apparatus, rotation of the apparatus, orientation of the apparatus, information obtained from a proximity sensor of the apparatus, information obtained from a gyroscope sensor of the apparatus, information related to reflector detection, or information related to blockage detection.

In some embodiments, the beam measurement information may be information related to a measured beam including at least one of: a RSRP of the measured beam, a reference signal received quality (RSRQ) of the measured beam, a signal-to-noise ratio (SNR) of the measured beam, a signal-to-interference-and-noise ratio (SINR) of the measured beam, interference power of the measured beam, or power of the measured beam.

In some embodiments, the device may be a base station. However, it should be noted that the device may be other type of device such as but not limited to an access point (AP), a transmit receive point (TRP) and a user equipment (UE).

According to an aspect of the disclosure there is provided a device for event-triggered operation in beam-based communication including a processor and a computer-readable medium. The computer-readable medium has stored thereon computer executable instructions that when executed cause the processor to perform a method consistent with the embodiment described above. Examples of different types of the network device include but not limited to a base station (BS), an access point (AP), a transmit receive point (TRP) and a user equipment (UE).

In some embodiments of the present disclosure, a device (e.g., a base station) may configure or determine event triggering information indicative of one or more conditions that when satisfied trigger an apparatus (e.g., UE) to perform a certain action (e.g., beam measurement, beam measurement reporting, other actions related to beam measurement procedure). The event triggering information and/or the one or more conditions may be configured or determined for that specific apparatus (i.e., the event triggering information and/or the one or more conditions may be apparatus-specific). This may result in less frequent beam measurement and report, and accordingly further result in less energy consumption and reduced transmission overhead associated with beam measurement or beam measurement feedback.

In some embodiments, apparatuses (e.g., UE) working in low power mode may save power effectively, as those apparatuses may provide less frequent beam measurement and feedback relying on information obtained from other apparatuses (e.g., relevant locations of the other apparatuses) providing correlated RSRP feedback.

In some embodiments, a framework may be provided for RSRP feedback adaptation rather than a single effort that try to exploit the correlation between the beam measurements and one or more aspects of the apparatuses.

In some embodiments, use of sensing information in determining whether one or more conditions to trigger an apparatus to perform a certain action may be beneficial especially in certain circumstances. For example, use of the sensing information may be useful for radio environment construction (e.g., in relation to network fingerprinting).

In some embodiments, use of sensing information in determining whether one or more conditions to trigger an apparatus to perform a certain action may be useful in relation to rotation-based events.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the present disclosure may occur.

FIG. 2 is another schematic diagram of a communication system in which embodiments of the present disclosure may occur.

FIG. 3 is a block diagram illustrating units or modules in a device in which embodiments of the present disclosure may occur.

FIG. 4 is a block diagram illustrating units or modules in a device in which embodiments of the present disclosure may occur.

FIG. 5A illustrates an example of several types of inputs that may be provided to determine whether a condition is satisfied and when a condition is satisfied, an action is performed according to embodiments of the present application.

FIG. 5B is a block diagram illustrating an example set of conditions that trigger an apparatus to perform certain actions, in accordance with embodiments of the present disclosure.

FIG. 6 illustrates an example of when one or more conditions trigger a UE on a highway to perform one or more actions, in accordance with embodiments of the present disclosure.

FIG. 7 illustrates an example of when one or more conditions trigger multiple UEs that are collocated in a common area, such as in a park, to perform one or more actions, in accordance with embodiments of the present disclosure.

FIG. 8A illustrates an example of a signal flow diagram between an apparatus, such as a UE, and devices, such as base stations, that enables reducing overhead caused by beam measurements and reporting, in accordance with embodiments of the present disclosure.

FIG. 8B illustrates another example of a signal flow diagram between an apparatus, such as a UE, and devices, such as base stations, that enables reducing overhead caused by beam measurements and reporting, in accordance with embodiments of the present disclosure.

FIG. 9 is a signal flow diagram illustrating an example process for event-triggered operation in beam-based communication, in accordance with embodiments of the present disclosure.

### DETAILED DESCRIPTION OF ILLUSTRATIVE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Aspects of the present disclosure described the use of new configurable events that may trigger a specified action, for example beam measurements and beam measurement reporting, based on at least one of beam measurement information or sensing information of an apparatus (e.g., user equipment (UE)). One example of beam measurement information is measured beam reference signal received power (RSRP). Examples of sensing information include one or more of location, speed, orientation of a UE. A device (e.g., base station) may determine or configure event triggering information indicative of one or more conditions that when satisfied may trigger the apparatus to perform a certain action. For example, a base station may configure one or more conditions defining how or when a UE may efficiently report the RSRP of one or more beams. Whether the one or more conditions are satisfied may be determined based on at least one of the beam measurement information or sensing information. The methods, apparatuses, and devices provided in the present disclosure may reduce the overhead that may be caused by the beam measurements and reporting, especially for high mobility apparatuses (e.g., high mobility UEs). Some conditions indicated in the event triggering information may trigger both beam measurements and beam measurement reporting. Some conditions indicated in the event triggering information may trigger only one of the beam measurements and beam measurement reporting. Some conditions indicated in the event triggering information may trigger a specific action in the beam management procedure that is not beam measurement or beam measurement reporting, for example beam switching.

In some embodiments, the device (e.g., base station) may determine or configure the event triggering information or the one or more conditions indicated in the event triggering information, or both, that are specific to the apparatus. The device may determine the event triggering information or the one or more conditions, or both, in consideration of a situation of the apparatus. The situation of the apparatus may include factors such as, but not limited to, location of the apparatus, velocity of the apparatus, other apparatuses served by same or neighbouring beams, or combinations thereof. The device may configure the apparatus with one or more events, each of which may include one or more conditions to trigger the apparatus to perform a certain action. Whether the one or more conditions are satisfied may be determined based on information acquired by the apparatus. In some embodiments, the apparatus may determine whether the one or more conditions are satisfied based on the event triggering information received from the device and at least one of the sensing information or the beam measurement information that the apparatus obtains. In some embodiments, the apparatus may be triggered to perform a certain action (e.g., when the conditions are met) and/or the apparatus may perform the certain action periodically. In some embodiments, when the one or more conditions are met, the apparatus may be triggered to perform one or more other actions, for example beam measurements, beam measurement reporting, other actions related to beam management procedure, or any combination thereof.

In some embodiments, one or more event-triggered operations (e.g., event-triggered beam measurements and reporting) may be beneficial in that overhead caused by beam measurements and reporting may be reduced. The overhead may be reduced by determining or configuring event triggering information or one or more conditions specific to the apparatus (e.g., tailored to a particular situation of the apparatus), or both. For example, periodic beams may be less frequently transmitted from the base station to the UE for the purpose of beam measurements and reporting, as the beam measurements and reporting may be triggered only when one or more conditions that are specifically configured for that UE are satisfied. Such event-triggered operation may be useful, especially for apparatuses (e.g., UE) operating in low power mode or with critical power constraints. Due to the reduced overhead, there may be more available communication resources to be exploited for other uses, potentially resulting an improved experience.

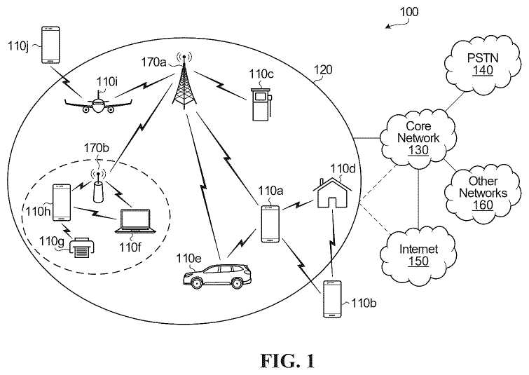

FIGS. 1, 2 and 3 following below provide context for the network and device that may be in the network and that may implement aspects of the present disclosure.

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

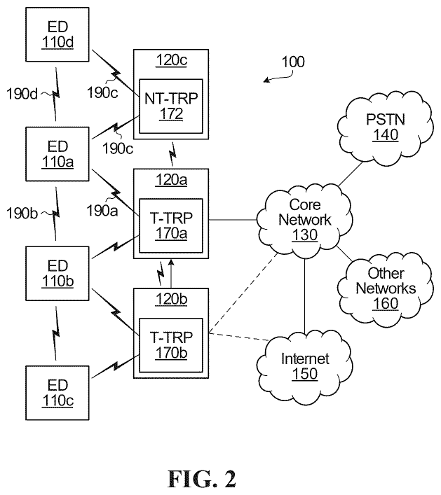

FIG. 2 illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 2, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 2 illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 2, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 2, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 2, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b,172 may implement Universal Mobile Telecommunication System (UMTS) Terrestrial Radio Access (UTRA) to establish an air interface 190a, 190c using wideband CDMA (WCDMA). In doing so, the base station 170a-170b.172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b,172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

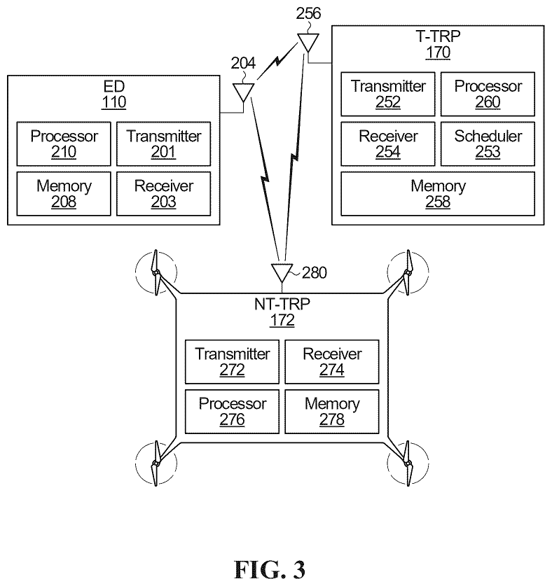

FIG. 3 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1 or 2). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

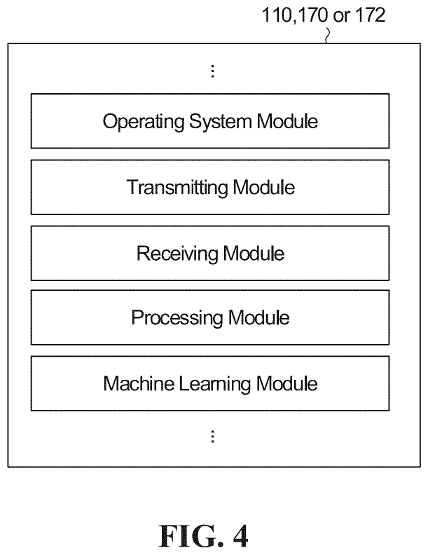

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture are restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. New protocol and signaling mechanisms are needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism needed so that the corresponding interface link can be performed with customized parameters to meet particular requirements while minimizing signaling overhead and maximizing the whole system spectrum efficiency.

AI/ML and sensing methods are data intensive. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Control information is referenced in some embodiments herein. Control information may sometimes instead be referred to as control signaling, or signaling. In some cases, control information may be dynamically communicated, e.g. in the physical layer in a control channel, such as in a physical uplink control channel (PUCCH) or physical uplink shared channel (PUSCH) or physical downlink control channel (PDCCH). An example of control information that is dynamically indicated is information sent in physical layer control signaling, e.g. uplink control information (UCI) sent in a PUCCH or PUSCH or downlink control information (DCI) sent in a PDCCH. A dynamic indication may be an indication in a lower layer, e.g. physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI sent in a PDCCH or UCI sent in a PUCCH or PUSCH.

In 5G NR, apparatuses and devices may have multiple antennas. For those apparatuses and devices, analog beamforming may be used to provide beamforming gains for communication links between apparatuses and devices. At higher frequencies, beam forming gains may be more critical because channel path losses may be significant. Analog beamforming may be performed for apparatuses and/or devices (e.g., a user equipment (UEs) or base station) with multiple antennas, in which each antenna is attached to a phase shifter at the apparatuses and/or devices. Instead of a signal being transmitted omnidirectionally, each phase shifter directs the signal at a particular angle (or angles in a particular range) or to a specific area.

A set of phases that direct the signal to a particular angle or direction may be called an analog beamformer. The analog beamformers may be grouped into a codebook. In one example, a discrete Fourier transform (DFT) matrix may be used as a codebook for analog beamforming that spans the angular domain, where each column of the DFT matrix is a beamformer that is steered to a particular angle and a number of rows of the DFT matrix is the number of antennas at the device.

As noted above, in beam-based communications, beam measurements are important for proper data transmission and decoding as well as beam and cell association, as communication parameters may be configured based at least partly on the beam measurement values. Conventionally, a UE periodically reports, to an associated base station, such as a base station serving the UE, a base station that may be a potential handover candidate, or a base station that may be used as part of beam failure recovery, the beam measurement values, for example the measured beam RSRP, signal to noise ratio (SNR), signal to interference and noise ratio (SINR), reference signal received quality (RSRQ), interference power, and/or signal power.

Whenever a UE changes its location, speed, or orientation, the beam to be reported to the associated base station may have different RSRP values, because the beam is configured to be transmitted at one or more particular angles or to a specific area. The UE may report, to the base station, measured RSRP values for different types of beams, for example serving beams, beams that may be used for beam switching, beams that may be used for beam failure recovery (BFR) and/or beams that may be used for potential handover (HO).

A base station in the network typically attempts to associate the UE with a beam that provides a high RSRP as a higher signal power would translate into a better performance (e.g., higher data rate). In some embodiments, the base station may request the UE to change from a first serving beam of the base station to a different serving beam through a beam switching procedure. In some embodiments, the base station may configure the UE to replace the failed serving beam with one or more other beams through a beam failure recovery procedure. In some embodiments, the serving base station may be changed to another base station through a handover procedure.

When a UE measures a beam RSRP, the measured beam RSRP value may be used to determine communication parameters. When a channel changes, the measured beam RSRP value may also change. While the channel may continually change, the channel changes may be more significant when the location, speed, or orientation of the UE changes. When there is a change in location, speed, or orientation of the UE, there may be a larger deviation in the measured beam RSRP value. Since the UE may have different profiles for UE location, movement, orientation, or combinations thereof, it may be useful to associate the beam RSRP reporting with sensing information of the UE (e.g., location, movement, orientation of UE). For example, UEs in a park, in an office, or in a car moving on a highway may all behave in different manners. Such different manners in behaviour may suggest different approaches (e.g., different configurations) for each UE in relation to the RSRP measurement reporting and feedback. This also suggests a benefit to providing different approaches for implementing event-triggered beam measurements and reporting.

Event-triggered beam measurements and reporting has been considered but limited to certain situations only. The rationale behind event-triggered procedures is to take actions only upon confirmation of the relevant situations based on the RSRP measurements. For example, a UE may enter or leave a serving cell region when the measured RSRP of the serving cell is better or worse than a predetermined threshold. In another example, a UE may move from a serving cell region to a neighbour cell when the measured RSRP of the neighbour cell is better than a predetermined neighbour cell threshold, when the measured RSRP of the serving cell is worse than a predetermined serving cell threshold, or when the RSRP of the neighbour cell is better than the serving cell by a certain offset value. In another example, a UE may move from a serving cell region to a neighbour cell when the inter-radio access technology (inter-RAT) of a neighbour cell is better than a predetermined neighbour cell threshold or when the measured RSRP of the serving cell is worse than a predetermined serving cell threshold or the inter-RAT of the neighbour cell is better than a predetermined inter-RAT threshold. However, such examples are limited to handover operations, and the handover operation is determined based only on beam measurements.

Aspects of the present disclosure provide a method that enables event-triggered operation such that an apparatus (e.g., UE) performs a specified action, such as beam measurements and reporting, when one or more conditions indicated in the event triggering information are satisfied. The UE may be configured to operate based on the event triggering information indicative of one or more conditions that when satisfied trigger the apparatus to perform the specified action. At least one of the event triggering information or the one or more conditions may determine when, how, or both, the apparatus (e.g., UE) may perform the specified action, for example reporting the measured beam RSRP to the associated device (e.g., base station). The event triggering information or the one or more conditions, or both, may be related to at least one of beam measurement information (e.g., RSRP) or sensing information (e.g., location, speed, orientation) of the UE. For example, an event that triggers the UE to perform a certain action may occur when the measured RSRP is greater than a predetermined threshold value or when the UE moves outside of a specific area.

According to some embodiments, a device (e.g., base station) may determine or configure the event triggering information for the apparatus (e.g., UE). Determining, by the device, the event triggering information may include determining one or more conditions that when satisfied, trigger the apparatus to perform a certain action, such as beam measurements and reporting. Configuring, by the device, the event triggering information may include the device sending configuration information pertaining to one or more conditions that when satisfied, trigger the apparatus to perform a certain action and configuration pertaining to certain action that may be performed.

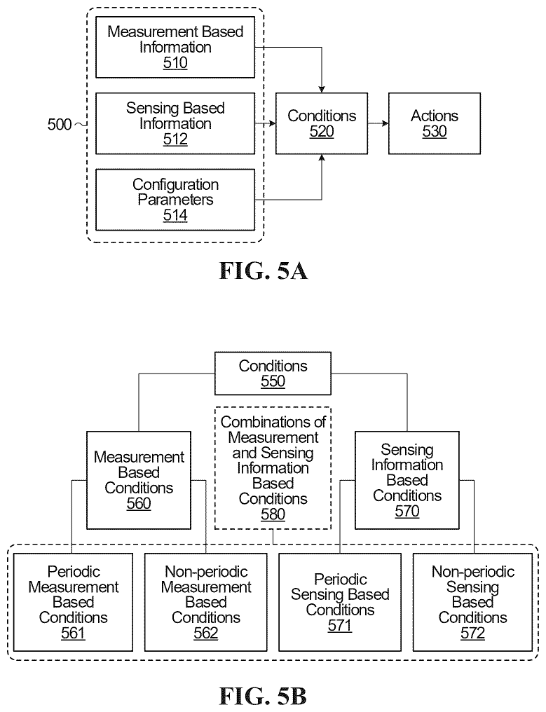

In some embodiments, determining whether the one or more conditions are satisfied may be performed based on the beam measurement information. In some embodiments, determining whether the one or more conditions are satisfied may be performed based on sensing information. Examples of beam measurement information and sensing information are provided below with regard to the description of FIGS. 5A and 5B. In some embodiments, whether the one or more conditions are satisfied may be determined based on a combination of the beam measurement information and the sensing information. In some embodiments, determining whether the one or more conditions are satisfied occurs at the apparatus.

In some embodiments, an apparatus may determine whether one or more conditions that when satisfied trigger an apparatus to perform a certain action based on a set of inputs, for example the beam measurement information or the sensing information, or both, discussed above and elsewhere in the present disclosure.

FIG. 5A illustrates an example of several types of inputs 500 that may be provided to determine whether a condition is satisfied and when a condition is satisfied, an action is performed according to embodiments of the present application. Examples of different types of inputs 500 may include, but are not limited to, measurement based information 510, sensing based information 512 and configuration parameters 514 that may be used to establish the conditions 520 that are to be satisfied. In the present disclosure, measurement based information may be referred to as measurement information, and sensing based information may be referred to as sensing information. Measurement based information 510 may include a RSRP, a reference signal received quality (RSRQ), a signal-to-interference-and-noise ratio (SINR), a signal-to-noise ratio (SNR), power, or interference power of the measured beam. Sensing based information 512 may include information such as apparatus (e.g., UE) location, apparatus velocity, apparatus speed, apparatus acceleration, apparatus rotation, apparatus orientation, apparatus elevation, information obtained from a proximity sensor of the apparatus, information obtained from a gyroscope sensor of the apparatus, information obtained from radar, information related to reflector detection (e.g., whether there are signal reflectors in the vicinity and where they may be), information related to other apparatus detection (e.g., whether there are other UEs in the vicinity and where they may be), information related to signal blockage detection (e.g., whether there are potential signal blockages in the vicinity and where they may be), and information related to line-of-sight (LOS) presence of other devices. The information obtained from the proximity sensor of the apparatus, the information obtained from radar, the information related to reflector detection, the information related to signal blockage detection, and/or information related to other apparatus detection may be environment sensing information. The apparatus (e.g., UE) may obtain the sensing information directly or indirectly. For example, a UE may obtain information related to the location of the UE directly from a global positioning system (GPS) sensor. In another example, a UE may obtain information related to rotation of the UE indirectly by combining information obtained from a GPS sensor and a laser imaging, detection, and ranging (LIDAR) sensor.

Conditions 520 may be measurement based conditions, sensing information based conditions or a combination of measurement based and sensing information based conditions. In some embodiments, a device (e.g., base station) sends configuration parameter information to the apparatus (e.g., UE). The apparatus may then use the inputs to determine whether a condition 520 is satisfied or not. When the conditions 520 are satisfied, actions 530 associated with the conditions 520 may be performed.

FIG. 5B is a block diagram illustrating an example set of conditions 550 that trigger an apparatus to perform certain actions, in accordance with embodiments of the present disclosure. Referring to FIG. 5B, the one or more conditions 550 may trigger an apparatus (e.g., UE) to perform certain actions based on at least one of measurement information 560, sensing information 570, and one or more combinations 580 thereof. The measurement information, sensing information, and one or more combinations of the measurement information and sensing information may be considered as one or more inputs used in determining whether the one or more conditions 550, which when satisfied, trigger the apparatus to perform a certain action, as shown in FIG. 5A. The one or more conditions 550 that trigger an apparatus (e.g., UE) to perform certain actions may include measurement-based conditions 560 and sensing-information-based conditions 570. Measurement-based conditions 560 may be periodic 561 in nature or non-periodic 562 in nature and configured to trigger the apparatus to perform measurements based on certain conditions. Sensing-information-based conditions 570 may likewise be periodic 571 in nature or non-periodic 572 in nature and configured to trigger the apparatus to perform sensing based on certain conditions.

The measurement information (which may include beam measurement information) and sensing information may be used in a method of determining whether one or more conditions 550, which when satisfied, trigger the apparatus to perform one or more (specified) actions. As noted above, measurement information and sensing information may be used as inputs to the one or more conditions 550 which may include a logical condition (e.g., A<B). Specifically, when determining whether the one or more conditions 550 are satisfied, some of the inputs (e.g., measurement based information 510 and sensing based information 512 in FIG. 5A) may be compared with predetermined threshold values to determine whether the one or more conditions 550 are satisfied. For example, the one or more conditions 550 may be satisfied when a certain input is greater or less than a threshold, when a first input is greater than a second input, when a first input is greater than a second input by a certain offset value, when a first input is close to a preconfigured threshold within a specific range, when a certain input is within or outside a specific range, or combinations thereof.

The one or more conditions 550 may include more than one logical condition. In some embodiments, the apparatus (e.g., UE) is triggered to perform a specified action when all of the logical conditions are satisfied. In some embodiments, the apparatus is triggered to perform a specified action when only some of the logical conditions are satisfied. Whether each logical condition is satisfied may be determined by comparing an input with a threshold value, or by comparing the difference between two inputs with a certain offset value. Some threshold value and/or offset value may be predetermined or preconfigured by a network or a network device (e.g., base station). Some threshold value and/or offset value may have a default value.

When the one or more conditions 550 are met, the apparatus (e.g., UE) may be triggered to perform one or more actions, for example beam measurements, beam measurement reporting, other actions related to beam management procedure, or any combination thereof. A person skilled in the art would readily understand that beam measurements performed when the one or more conditions 550 are satisfied should be distinguished from beam measurements performed to obtain measurement information used in determining whether the one or more conditions 550 are satisfied.

The periodic measurement-based conditions 561 shown in FIG. 5B may trigger an apparatus (e.g., UE) to periodically perform one or more configured or predetermined actions, such as beam measurements and reporting at a certain time interval (e.g., every N minutes). In some embodiments, the periodic measurement-based conditions 561 may depend on sensing information. In some embodiments, when the periodic measurement-based conditions 561 are satisfied, an action performed by an apparatus may be similar to the conventional beam reporting.

The non-periodic measurement-based conditions 562 shown in FIG. 5B may trigger an apparatus (e.g., UE) to perform an action according to certain condition(s) related to the beam measurements. For example, the non-periodic measurement-based conditions 562 may trigger a UE to report the beam measurements when the measured RSRP is greater than a certain threshold. In another example, the non-periodic measurement-based conditions 562 may trigger a UE to report the beam measurements when the measured RSRP is less than a certain threshold. In another example, the non-periodic measurement-based conditions 562 may trigger a UE to report the beam measurements when the measured RSRP of a first beam is greater than the measured RSRP of a second beam by a certain offset. There may be various relations between the beam measurements (e.g., measured beam RSRPs) and configured parameter values (e.g., thresholds, offsets) that trigger an apparatus to perform an action.

The periodic sensing-information-based conditions 571 shown in FIG. 5B may trigger an apparatus (e.g., UE) to perform the beam measurements and reporting based on a certain extent of change in location or direction of an apparatus. The location change of the apparatus may be determined based on an absolute distance moved by the apparatus, or an angular distance moved by the apparatus in a certain direction (e.g., cardinal directions of north, south, east, and west), or a distance moved by the apparatus in a Cartesian coordinate system (e.g., x-axis, y-axis, z-axis), or a relative direction compared to the location, movement, or both, of the apparatus (e.g., ahead, back, right, left, clock-wise rotation, counter-clock-wise rotation). For example, the apparatus may be triggered to perform an action whenever the apparatus moves M meters or rotates R degrees. In other words, the apparatus may be triggered to perform an action whenever the apparatus obtains sensing information that, for example, the apparatus moved M meters or rotated R degrees.

The non-periodic sensing-based conditions 572 shown in FIG. 5B may trigger an apparatus (e.g., UE) to perform an action according to one or more conditions related to sensing information. For example, the non-periodic sensing-based conditions 572 may trigger a UE to report beam measurements when the apparatus moves a certain distance (e.g., M meters) in any direction, a specific direction, or a relative direction. In another example, the non-periodic sensing-based conditions 572 may trigger a UE to report the beam measurements when the UE rotates more than a certain degree or when the apparatus accelerates more than a certain amount. Put another way, the non-periodic sensing-based conditions 572 may include that if the sensing information obtained by a UE indicates that the UE has rotated more than a certain degree, the UE reports the beam measurements to the base station. In another example, the non-periodic sensing-based conditions 572 may trigger a UE to report the beam measurements when speed of the UE decreases more than a designated threshold (e.g., when a mobile device leaves the highway). Put another way, the non-periodic sensing-based conditions 572 may include that if the sensing information obtained by a UE indicates that the speed of the UE has decreased more than a predetermined threshold, the UE reports the beam measurements to the base station.

In some embodiments, the non-periodic sensing-based conditions 572 may trigger an apparatus to report the beam measurements based on the sensing information related to other objects. For example, a UE may be triggered to report the beam measurement based on movement of another object (e.g., a nearby reflecting object). In another example a UE may be triggered to report the beam measurement based on a change in distance between the UE and another object. In another example, a UE may be triggered to report the beam measurement when the UE detects other nearby UEs. In another example, a UE may be triggered to report the beam measurement based on a change from a LOS link to a non-line-of-sight (NLOS) link between the UE and another UE, or vice versa.

In some embodiments, the one or more conditions 550 that trigger an apparatus (e.g., UE) to perform certain actions may include combinations 580 of the measurement-based conditions 560 and the sensing-information-based conditions 570. In other words, the combinations 580 may include any of the periodic measurement-based conditions 561, non-periodic measurement-based conditions 562, the periodic sensing-information-based conditions 571, and the non-periodic sensing-based conditions 572. For example, a UE may be triggered to report a beam measurement when the UE moves a certain distance and the measured RSRP of a serving beam is greater than a predefined threshold value. In another example, a UE may be triggered to report a beam measurement when the UE rotates in a certain direction more than a predetermined amount or the measured RSRP of a serving beam is decreased more than a predetermined value. Put another way, a UE may report a beam measurement if one of the sensing information based condition 570 and the measurement based condition 560 is satisfied. In another example, a UE may be triggered to report a beam measurement when the speed of the UE changes more than a certain amount and the change of the measured RSRP of a serving beam is greater than a predetermined value. Put another way, a UE may report a beam measurement if both of the sensing information based condition 570 and the measurement based condition 560 are satisfied.

In some embodiments, the one or more conditions 550 may trigger an apparatus (e.g., UE) to perform beam measurements. For example, a UE may be triggered to perform beam measurements when the periodic measurement-based conditions 561 are satisfied or when the UE moves a certain distance. The UE may keep track of UE movements. When the UE moves more than a predetermined threshold distance, the UE may perform beam measurements, such as RSRP, and report the measured RSRP to a base station. In some embodiments, the beam measurement reporting may include a UE-initiated RSRP feedback procedure. In such case, the UE may transmit, to the base station, an indication that the UE is going to transmit the RSRP feedback (e.g., measured beam RSRP). Then, the UE may report the RSRP feedback using the resources set by the base station to provide the RSRP feedback. In some embodiments the resources to transmit the RSRP feedback may be included in configuration information provided by the base station that is related to the action that the UE is going to perform, in this case the RSRP feedback or beam measurement reporting. In some embodiments, the UE may know in advance the resource to use for transmission of the RSRP feedback or beam measurement reporting. In such case, the UE may transmit the RSRP feedback to the base station without sending an indication that the UE is going to transmit the RSRP feedback.

In some embodiments, the one or more conditions 550 may trigger an apparatus (e.g., UE) to perform other actions related to beam management. For example, the UE may be configured to measure the RSRP of a certain beam (i.e., a new beam) that is not a serving beam. When the measured RSRP of the new beam is greater than the measured RSRP of the serving beam by a certain value (e.g., predetermined value), the UE may report the measured RSRP of the new beam and perform beam switching (e.g., switching from the serving beam to the new beam).

In some embodiments, the one or more conditions 550 may be based on one or more logical relationships, linear relationships, or non-linear relationships between configured or default parameters (e.g., a predetermined threshold value) and the measurement information (e.g., beam measurement information) and/or between the configured or default parameters and the sensing information. The one or more actions may include, but are not limited to, beam measurements, beam measurement reporting, other actions related to beam management, or any combinations thereof.

When the actions triggered by the one or more conditions 550 include performing beam measurements, beam measurement reporting, or both, the base station may transmit periodic beams so that the UE may perform the beam measurements, the beam measurement reporting, or both using the periodic beams. However, in order to reduce energy consumption at the base station, the base station may transmit the beams only when the UE is triggered to measure or measure and report. In this way, the base station may reduce the required periodic beam transmissions. For example, the base station may transmit the beams only when the UE informs the base station that the UE is going to perform beam measurements, beam measurement reporting, or both. In another example, the base station may transmit the beams only when the base station detects that the UE may perform the beam measurements, beam measurement reporting, or both, soon. For example, movement of the UE may be detected by a base station, and the base station may consider movement of the UE in a certain direction (as configured by the base station) a trigger to perform the beam measurements, beam measurement reporting, or both.

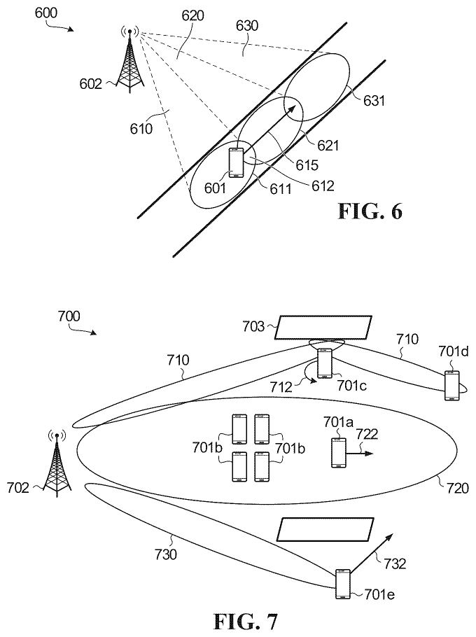

In some embodiments, the one or more conditions that trigger a certain action may be configured to be specific to a particular UE or a group of UEs. In some embodiments, the one or more conditions, may be tailored to UEs operating under different operational conditions, for example, stationary UEs, UEs held by pedestrians, low mobility UEs, or high mobility UEs. In some embodiments, the one or more conditions may be configured or determined based on information that may be determined from a map. For example, the conditions may be configured or determined based on whether the UE is on a driveway, sidewalk, highway or in the park. Such information may be determined based on comparison of GPS date to a map so as to determine where a UE map be located based on the map information. In some embodiments, the one or more conditions may be determined or configured in consideration of one or more parameters or capabilities of the UE. Examples of such parameters or capabilities include, but are not limited to, low power consumption, high reliability, and low latency. By determining or configuring the conditions to a certain apparatus (or a group of apparatuses), the apparatus may perform certain actions more effectively. For example, a stationary UE may be able to perform beam measurements and reporting less frequently as the channel conditions may be relied upon to remain the same for longer periods of time as the UE is not moving. A UE determined to be in a park may perform less beam measurement reporting because the UE reports the beam measurements only when it moves more than a certain distance ands when someone is in a park they tend to stay at the park for a period of time. A UE that is determined to be on a highway may be configured to perform beam measurements, beam measurement reporting, and beam switching only under certain conditions (e.g., when a UE enters a coverage area of a particular beam as illustrated above and FIG. 6). When configured in this way, the UE may perform beam switching in a more reliable manner while performing beam measurements and reporting less frequently.

The apparatus may transmit, to a device (e.g., base station), information indicative of one or more capabilities of the apparatus in relation to obtaining at least one of the sensing information or the beam measurement information. The device may determine or configure the one or more conditions for that apparatus in consideration of the capability of that apparatus. For example, the one or more conditions may be determined or configured such that the apparatus is capable of determining whether the one or more conditions are satisfied based on at least one of the sensing information or the beam measurement information obtained by that apparatus. Some apparatuses may be capable of obtaining various beam measurement information (e.g., RSRP, RSRQ, etc.) and sensing information (e.g., location, speed, rotation, etc.), whereas some other apparatuses may be capable of obtaining limited types of beam measurement information or sensing information, or both. As such, capabilities of apparatuses in relation to obtaining sensing information or beam measurement information, or both, may be an important factor when determining or configuring the one or more conditions. For example, some older mobile devices may not be able to obtain information related to angular velocity due to a lack of having a gyroscope sensor in the mobile device. In such a case, if determining whether a condition is satisfied is based on the angular velocity of an apparatus, it may not be possible for some apparatuses, such as older mobile devices to perform such a determination. In some embodiments, selecting suitable conditions for apparatuses may be related to the capability of those apparatuses.

FIG. 6 illustrates an example of when one or more conditions trigger a UE on a highway to perform one or more actions, in accordance with embodiments of the present disclosure. Referring to FIG. 6, a wireless network 600 includes a UE 601 and a transmit receive point (TRP) 602 that is in communication with the UE 601. The TRP 602 may be a base station. The TRP 602 transmits a plurality of beams including a first beam 610, a second beam 620, and a third beam 630. Each of the beams include a cover area. In FIG. 6, at a first instance in time, the UE 601 and the TRP 602 communicate using the first beam 610 when the UE is within coverage area 611. As the UE 601 is on a highway, the UE 601 may be moving at a high speed. The UE 601 may be triggered to perform the beam measurements and reporting when the UE 601 is moving faster than a predetermined threshold, if that is a condition to trigger the UE 601 to perform beam measurements and reporting and the condition is satisfied. The UE 601 may be triggered to perform the beam measurements and reporting based on the location of the UE 601, e.g., when the UE 601 is located near the edge of the area covered by the beam 610. In other words, the condition to trigger the UE 601 to perform beam measurements and reporting may be related to the location of the UE 601.

The UE 601 may perform beam switching based on its location. For example, when the UE 601 is located at the edge of the area covered by the first beam 610 or in an overlapping area 612 of both the first beam 610 and the second beam 620, and the UE 601 is moving in the direction of the arrow 615 (e.g., from the area 611 covered by the first beam 610 to the area 621 covered by the second beam 620), the condition to trigger the UE 601 to perform beam switching may be satisfied. When the condition is satisfied, the UE 601 may switch a serving beam from the first beam 610 to the second beam 620 for communication with the TRP 602.

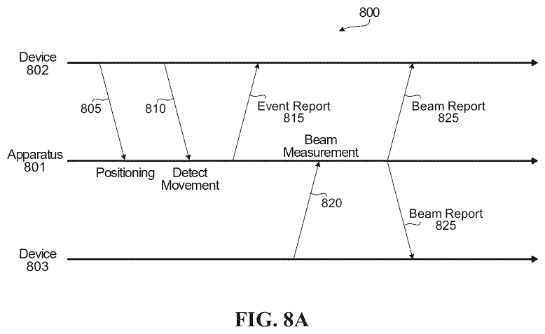

FIG. 7 illustrates an example of when one or more conditions trigger multiple UEs that are collocated in a common area, such as in a park, to perform one or more actions, in accordance with embodiments of the present disclosure.

Referring to FIG. 7, a wireless network 700 includes UEs 701a-70le and a TRP 702. The TRP 702 may be a base station. The TRP 702 transmits a plurality of beams including a first beam 710, a second beam 720, and a third beam 730. The first beam 710 is used for communication between the TRP 702 and the UE 701c and communication between the TRP 702 and the UE 701d. The first beam 710 is transmitted in the direction of both the reflector 703 and the UE 701c. The reflector 703 redirects the transmitted beam to the UE 701d. The UEs 701c and 701d are not moving and are staying within the area covered by the first beam 710, and therefore the UEs 701c and 701d may not be triggered to perform beam measurements and reporting because the conditions to trigger the UEs 701c and 701d to perform beam measurements and reporting are not satisfied.

The UE 701c may use a narrow beam for receiving communications transmitted on the transmit beam 710 by the TRP 702. The UE 701c may be capable of beamforming and therefore use multiple beams. When the UE 701c is moved in a manner that involves rotation of the UE 701c (as indicated in the arrow 712), the receive beam being used may no longer be aligned with the transmit beam 710. Therefore, a condition that when satisfied may trigger the UE 701 to perform an action may be that the UE 701c rotates greater than a threshold value. For example, due to the nature of the received beam being narrow, it may be understood that a rotation of 7 degrees of the UE 701c may result in a noticeable reduction of received power at the UE 701c due to the transmit and received beams not being aligned. When the rotation is determined to exceed the threshold of 7 degrees, an action may be for the UE 701c to perform measurements of other beams to determine if there are any beams that may have a higher received power (e.g., RSRP). As a result, the UE 701c may switch to a different beam if there is determined to be a beam with a higher received power. While 7 degrees is discussed above, it is to be understood that such an angle is only an example and a rotation threshold would vary dependent on desired implementation.

A UE may determine an amount of rotation by information received from a gyroscope or indirectly by combining information obtained from a GPS sensor and a laser imaging, detection, and ranging (LIDAR) sensor. A UE may experience rotation for many reasons. For example, simply adjusting a laptop may cause rotation of the device, or using a device for augmented reality (AR) or virtual reality (VR) may result in a UE undergoing rotation, which may trigger an action, but not signification movement.

The UE 701a is moving away from the TRP 702 in a direction indicated by arrow 722, which is along a longitudinal direction of the second beam 720 at a moderate speed. The UE 701a may perform beam measurements and reporting when the UE 701a is moving fast, for example faster than a predetermined threshold, and therefore the condition to trigger the UE 701a to perform beam measurements and reporting is satisfied. However, the UE 701a may not perform beam switching because the UE 701a is still located near a center of the area covered by the second beam 720 (i.e., far from the edge of the area covered by the beam 720). In other words, conditions to trigger the UE 701a to perform beam switching are not satisfied.

The four UEs 701b are located at or near the center of the area covered by the second beam 720 and the four UEs 701b are not moving (or are moving at a low speed). Therefore, the UEs 701b may not be triggered to perform beam measurements and reporting because the conditions to trigger the four UEs 701b to perform beam measurements and reporting are not satisfied.

The UE 701e is moving away from the TRP 702 at a moderate speed in a direction indicated by arrow 732, which is almost perpendicular to the longitudinal direction of the third beam 730. The UE 701e may perform beam switching because the UE 70le is moving from the edge of the area covered by the third beam 730 towards the area covered by the second beam 720 and the speed of the UE 701e is faster than a predetermined threshold, because conditions to trigger the UE 701e to perform beam switching are satisfied.

The TRP 702 may configure or determine one or more conditions, which when satisfied, trigger the some or all of UEs 701a-701e to perform one or more actions based on information of each of the UEs 701a-701e. The TRP 702 may configure or determine one or more conditions specific to each of the UEs 701a-701e. In some embodiments, the TRP 702 may not need all available information to determine the event-triggering conditions from the UE 701d. As the UE 701d and the TRP 702 communicate via the reflector 703 and the UE 701c is located at or near the reflector 703, the TRP 702 may be able to use the information obtained from other apparatuses (e.g., UE 701c) for the purpose of determining or configuring the conditions specific to the UE 701d. The TRP 702 may obtain, from the UE 701d, part of the information that the UE 701d is able to provide, e.g., information related to the beam transmission between the reflector 703 and the UE 701d.

The apparatus may determine whether the one or more conditions are satisfied based on information obtained by measurements performed at the apparatus. The information obtained by measurements performed at the apparatus may include the beam measurement information. In some embodiments, the apparatus may be configured with regard to how to perform such measurements. In some embodiments, the apparatus may perform measurements in accordance with a predetermined protocol.

In some embodiments, one or more predetermined default values may be used as inputs for the one or more conditions. The default values may be useful, for example, when the apparatus is not able to obtain, or does not obtain, one or more conditions in the form of configuration information from the base station or sensing information.

When the one or more conditions associated with an event are satisfied, the apparatus (e.g., UE) may perform one or more configured actions. The apparatus may perform the configured action directly, without informing the device (e.g., base station), or after sending an indication to the device that the apparatus is going to perform the configured actions. Some actions may be performed directly by the apparatus based on a previous configuration. The actions that may be directly performed by the apparatus may include measuring one or more existing beams and reporting the beam measurements (e.g., measurement beam RSRP reporting). In some embodiments, the apparatus transmits an indication to the device that the apparatus is going to perform those actions before actually performing the actions. An example of an action for which the apparatus transmits the indication first may include measuring a certain aperiodic beam transmitted from the device.

In some embodiments, an apparatus may be configured to perform multiple actions in a sequential manner based on the one or more conditions. For example, when a condition related to the location of a UE is satisfied, the UE is triggered to measure a RSRP of a certain beam. Then, a condition related to the measured beam RSRP is satisfied (e.g., the measured beam RSRP is greater than a RSRP of a serving beam by a predetermined value) and therefore further triggers the UE to initiate beam switching. In another example, when a condition related to the speed of a UE is satisfied, the UE is triggered to measure a RSRP of a certain beam. Then, a condition related to the measured beam RSRP is satisfied (e.g., the measured beam RSRP is greater than a predetermined threshold value) triggers the UE to add the measured beam to a set of beams to be used in a beam failure recovery procedure.

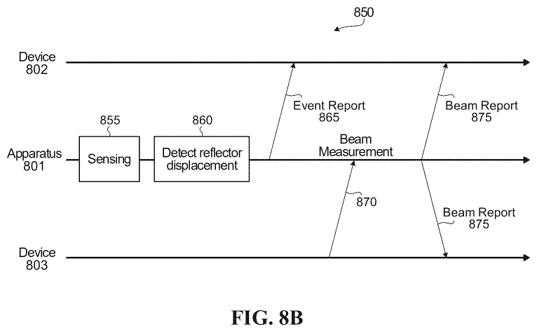

FIG. 8A illustrates an example of a signal flow diagram 800 between an apparatus 801, a first device 802 and a second device 803 that enables reduction of overhead caused by beam measurements and reporting, in accordance with embodiments of the present disclosure. The apparatus 801 may be a UE. The first device 802 may be a base station that transmits sub-6 GHz signals, and the second device 803 may be a high frequency network node or a base station that transmits millimeter wave (mmWave) signals. The apparatus 801 may be communicatively connected to the first and second devices 802 and 803 using a low-band frequency link and a mmWave link, respectively.

At step 805, the apparatus 801 may receive, from the first device 802, a beam transmitted through the low-band frequency link. The apparatus 801 may estimate the apparatus location using the beam transmitted from the first device 802. The apparatus 801 may be able to determine apparatus movement based on the estimated apparatus location.

The apparatus 801 may also have event triggering information indicative of one or more conditions related to the location or movement, or both, of the apparatus 801. The one or more conditions may be satisfied when the apparatus 801 moves in a specific direction (e.g., east, west, south, and north), or within a specific range of angles, or both. The one or more conditions may be satisfied when the apparatus 801 moves more than a certain distance in a non-specified direction (e.g., more than distance thresholds for other directions. For example, if the specified direction is east, when the apparatus 801 moves more than the distance threshold in west, south, or north, then the one or more conditions may be satisfied. The one or more conditions, when satisfied, may trigger the apparatus 801 to perform beam measurements and reporting. The event triggering information may be received from the first device 802.

Therefore, the apparatus 801 may be configured to measure one or more beams and report the beam measurements when the one or more conditions related to the location or movement, or both, of the apparatus 801 are satisfied.

At step 810, the apparatus 801 may detect that the apparatus 801 is moving in a specific direction based on signaling received from the first device 802. The movement of the apparatus 801 in the specific direction may satisfy the one or more conditions that trigger the apparatus 801 to perform the beam measurements and reporting. Whether the one or more conditions are satisfied may be determined by, for example, comparing the movement of the apparatus 801 and a predetermined threshold value, e.g., direction-specific distance threshold.

If the apparatus 801 determines the one or more conditions are satisfied, the apparatus 801 at step 815 may inform the first device 802 that the one or more conditions related to movement of the apparatus 801 are satisfied. In some embodiments, the apparatus 801 transmits an event report to the first device 802, as shown in FIG. 8A.

At step 820, the second device 803 may transmit one or more beams to the apparatus 801 so that the apparatus 801 may measure the one or more beams and report the measurement of the one or more beams. In some embodiments, the one or more beams transmitted from the second device 803 may be aperiodic beams. In such embodiments, when the one or more conditions are satisfied, the apparatus 801 may transmit an indication to the first device 802 and/or the second device 803 that the apparatus 801 is going to perform the beam measurements and reporting before the apparatus 801 actually performs the beam measurements and reporting. In some embodiments, the apparatus 801 may transmit a first indication to the first device 802 that the apparatus 801 is going to perform the beam measurements and reporting. After receiving the first indication from the apparatus 801, the first device 802 may transmit a second indication to the second device 803 that the apparatus 801 is going to perform the beam measurements and reporting. After receiving the second indication from the first device 802, the second device 803 may start transmitting, to the apparatus 801, aperiodic beams that the apparatus 801 may measure and report.

In some embodiments, the one or more beams transmitted from the second device 803 at step 820 may be periodic beams.

In such embodiments, when the one or more conditions are satisfied, the apparatus 801 may directly measure the beams and report the beam measurements without sending any indication to the first device 802 and/or the second device 803 that the apparatus 801 is going to perform the beam measurements and reporting.

While FIG. 8A illustrates that the apparatus 801 may perform the beam measurement using one or more beams from the second device 803, in some embodiments, the apparatus 801 may perform the beam measurement using one or more beams from the first device 802. In some embodiments, the apparatus 801 may perform the beam measurement using beams from both the first and second devices 802 and 803.

At step 825, the apparatus 801 may transmit the beam measurement report to the first device 802 and/or the second device 803.

FIG. 8B illustrates another example of a signal flow diagram 850 between the apparatus 801, such as a UE, and the first and second devices 802 and 803, such as base stations, that enables reducing overhead caused by beam measurements and reporting, in accordance with embodiments of the present disclosure. The apparatus 801 and the first and second devices 802 and 803 shown in FIG. 8B may be the same apparatus and devices shown in FIG. 8A. The apparatus 801 may be communicatively connected to the first and second devices 802 and 803 using a low-band frequency link and a mmWave link, respectively.

At step 855, the apparatus 801 may obtain sensing information such as location of the apparatus 801, speed of the apparatus 801, velocity of the apparatus 801, acceleration of the apparatus 801, rotation of the apparatus 801, orientation of the apparatus 801, information obtained from a proximity sensor of the apparatus 801, information obtained from a gyroscope sensor of the apparatus 801, information related to reflector detection, and/or information related to signal blockage detection. The apparatus 801 may obtain the sensing information without help of the network.

In this example, the apparatus 801 may have event triggering information indicative of one or more conditions related to displacement of a certain reflector. The one or more conditions may be satisfied when the certain reflector is displaced relative to, for example, a predetermined reference point or a previous position of the reflector. For example, the one or more conditions may be satisfied when the apparatus 801 senses or identifies that a reflector, which was located within a certain range of angle of arrival (AoA) of an active beam pair that is used for communication between the apparatus 801 and the second device 803, has moved by a certain distance or a certain angle. The one or more conditions, when satisfied, may trigger the apparatus 801 to perform beam measurements and reporting. The event triggering information may be received from the first device 802.

Therefore, the apparatus 801 may be configured to measure one or more beams and report the beam measurements when the one or more conditions related to the displacement of the reflector are satisfied.

At step 860, the apparatus 801 may detect displacement of the reflector. The movement of the reflector may satisfy the one or more conditions that trigger the apparatus 801 to perform the beam measurements and reporting. Whether the one or more conditions are satisfied may be determined by for example comparing the movement of the reflector and a predetermined threshold value (e.g., a certain distance threshold).

If the apparatus 801 determines the one or more conditions are satisfied, the apparatus 801 at step 865 may inform the device 802 that the one or more conditions related to displacement of the reflector are satisfied. In some embodiments, the apparatus 801 transmit an event report to the first device 802 as shown in FIG. 8B.

At step 870, the second device 803 may transmit one or more beams to the apparatus 801 so that the apparatus 801 may measure the one or more beams and report the measurement of the one or more beams. In some embodiments, the one or more beams transmitted from the second device 803 may be aperiodic beams. In such embodiments, when the one or more conditions are satisfied, the apparatus 801 may transmit an indication to the first device 802 and/or the second device 803 that the apparatus 801 is going to perform the beam measurements and reporting before it actually performs the beam measurements and reporting. In some embodiments, when the one or more conditions are satisfied, the apparatus 801 may transmit a first indication to the first device 802 that the apparatus 801 is going to perform the beam measurements and reporting. After receiving the first indication from the apparatus 801, the first device 802 may transmit a second indication to the second device 803 that the apparatus 801 is going to perform the beam measurements and reporting. After receiving the second indication from the first device 802, the second device 803 may start transmitting, to the apparatus 801, aperiodic beams that the apparatus 801 may measure and report. In some embodiments, the one or more beams transmitted from the second device 803 may be periodic beams. In such embodiments, when the one or more conditions are satisfied, the apparatus 801 may directly measure the beams and report the beam measurements without sending the indication to the first device 802 and/or the second device 803.

While FIG. 8B illustrates that the apparatus 801 may perform the beam measurement using one or more beams from the second device 803, in some embodiments, the apparatus 801 may perform the beam measurement using one or more beams from the first device 802. In some embodiments, the apparatus 801 may perform the beam measurement using beams from both the first device 802 and the second device 803.

At step 875, the apparatus 801 may transmit the beam measurement report(s) to the first device 802 and/or the second device 803.

The example illustrated above and FIG. 8B may be relevant to adapting to reflector movement, preventing a potential signal blockage, or tracking a current signal blockage that may be related to movement of the apparatus 801 or movement of the signal blockages (e.g., a truck).

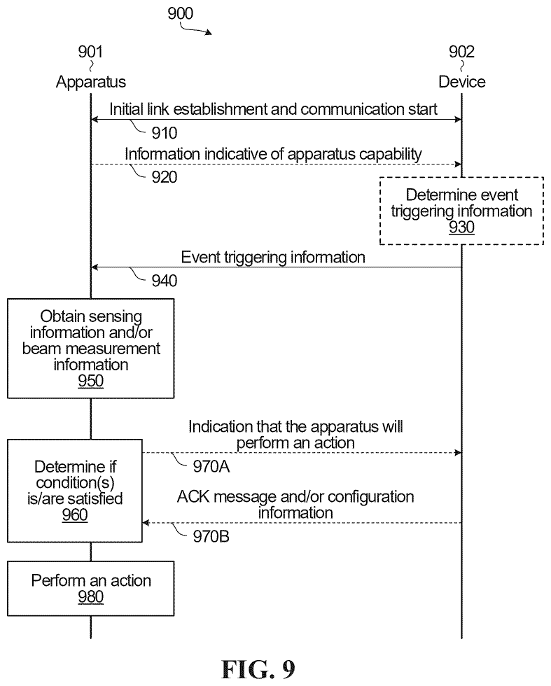

FIG. 9 is a signal flow diagram 900 illustrating an example process for event-triggered operation in beam-based communication between an apparatus 901 and a device 902, according to embodiments of the present disclosure. Referring to FIG. 9, in some embodiments, the apparatus 901 may be a UE, and the device 902 may be a base station. In some other embodiments, the apparatus 901 may be a base station, and the device 902 may be a UE. In some other embodiments, the apparatus 901 and the device 902 may both be UEs. In some other embodiments, the apparatus 901 and the device 902 may both be base stations.

In some embodiments, at step 910, the apparatus 901 and the device 902 may establish a communication link. The apparatus 901 and the device 902 may communicate using the established communication link.

In some embodiments, at step 920, the apparatus 901 may optionally, as denoted by the dashed line, transmit information indicative of capability of the apparatus 901 in relation to obtaining at least one of the sensing information or the beam measurement information. Examples of information indicative of the capability of the apparatus 901 may include information such as whether the apparatus 901 is capable of obtaining the sensing information. Some examples of the sensing information are provided above and elsewhere in the present disclosure.

In some embodiments, at step 930, the device 902 may determine event triggering information indicative of one or more conditions. The one or more conditions when satisfied may trigger the apparatus 901 to perform an action. In some embodiments, the action to be performed by the apparatus 901 may include at least one of: performing beam RSRP measurement, transmitting a beam measurement report, performing beam switching, or adding a beam to a set of beams to be used in a beam failure recovery procedure. In some embodiments, the device 902 may determine or configure the event triggering information based on the information received at step 920. For example, the device 902 may determine or configure the event triggering information based on information indicative of capability of the apparatus 901, sensing information obtained by the apparatus 901 and provided to the device 902, requirements of the apparatus 901 (e.g., requirements for communication of the apparatus 901), or combinations thereof. In another example, the device 902 may determine or configure the event triggering information based on a current status of the apparatus 901 (e.g., a location of the apparatus such as whether the apparatus 901 is in a park or on a highway). The device 902 may determine or configure the event triggering information specific to the apparatus 901. In other words, the event triggering information may be customized for the apparatus 901 and therefore specifically suitable to the apparatus 901. In some embodiments, the event triggering information that the device 902 determines or configures may include one or more parameters (e.g., inputs, thresholds) used to determine whether the one or more conditions are satisfied. Step 930 may be an optional step. In some embodiments where step 930 is an optional step, the device 902 may obtain the event triggering information and transmit to the apparatus 901. In some of such cases, the event triggering information may be configured or determined by another device.

At step 940, the device 902 may transmit, to the apparatus 901, the event triggering information. In some embodiments, the event triggering information may be the event triggering information determined by the device 902 at step 930. However, in some embodiments, while FIG. 9 illustrates that the device 902 transmits the event triggering information to the apparatus 901, the event triggering information may be preconfigured or predetermined by one or more other devices and the one or more other devices may provide the preconfigured or predetermined event triggering information to the apparatus 901. In any case, the event triggering information transmitted or provided to the apparatus 901 may be specific to the apparatus 901.

In some embodiments, the event triggering information transmitted to the apparatus 901 may include information indicative of at least one of: a condition associated with a measured reference signal received power (RSRP) of a beam, a condition based on the sensing information, a condition based on a change in the sensing information, or a condition based on a combination thereof. In some embodiments, the condition associated with the measured RSRP of the beam may include a measured RSRP of a serving beam being less than a measured RSRP of another beam by a predetermined value. In some embodiments, the condition based on the sensing information or the condition based on the change in sensing information may include at least one of: displacement of a reflector, movement of the apparatus 901 in a specific direction or outside of a specific angular range, or speed of the apparatus 901 being faster than a threshold speed. In some embodiments, the event triggering information transmitted to the apparatus 901 may include information indicative one or more parameters (e.g., inputs, thresholds) used to determine whether the one or more conditions are satisfied.

In some embodiments, the apparatus 901 may continually or periodically check if any of the one or more conditions are satisfied until the apparatus 901 is notified to no longer check whether conditions are satisfied or until a timer associated with continually checking expires.

At step 950, the apparatus 901 may obtain sensing information related to the event triggering information and/or beam measurement information related to the event triggering information. The sensing information may include at least one of: location of the apparatus 901, speed of the apparatus 901, velocity of the apparatus 901, acceleration of the apparatus 901, rotation of the apparatus 901, orientation of the apparatus 901, information obtained from a proximity sensor of the apparatus 901, information obtained from a gyroscope sensor of the apparatus 901, information related to reflector detection, or information related to signal blockage detection. The beam measurement information may be information related to a measured beam including at least one of: RSRP of the measured beam, RSRQ of the measured beam, SNR of the measured beam, SINR of the measured beam, interference power of the measured beam, or power of the measured beam. In some embodiments, the apparatus 901 may obtain at least one of the sensing information or the beam measurement information periodically. While obtaining sensing information and/or beam measurement information is shown in a particular order at step 950, it should be understood that the apparatus 901 may obtain sensing information and/or beam measurement information at other times during the example process for event-triggered operation in beam-based communication shown in the signal flow chart 900.

At step 960, the apparatus 901 determines whether the one or more conditions are satisfied based on the event triggering information and at least one of the sensing information or the beam measurement information. In some embodiments, the apparatus 901 may determine whether the one or more conditions are satisfied based on one or more preconfigured thresholds to compare with at least one of the sensing information or the beam measurement information.

In some embodiments, at step 970A when the one or more conditions indicated by the event triggering information are satisfied, the apparatus 901 may transmit, to the device 902, an indication that the apparatus 901 is going to perform the action (e.g., beam measurements and reporting). In response to the indication, the device 902, at step 970B, may transmit, to the apparatus 901, at least one of an acknowledgement message or configuration information related to performing the action. The configuration information may be information used by the apparatus 901 to perform the action properly. Steps 970A and 970B may be optional steps. In some embodiments, when at step 970A the apparatus 901 transmits the indication that the event is being triggered, the device 902 may not transmit at 970B the acknowledgement message and/or configuration information to the apparatus 901.

At step 980, the apparatus 901 may perform the action when the one or more conditions indicated by the event triggering information are satisfied. As noted above, in some embodiments, the action to be performed by the apparatus 901 may include at least one of: performing beam RSRP measurement, transmitting a beam measurement report (e.g., apparatus feedback), performing beam switching, or adding a beam to a set of beams to be used in a beam failure recovery procedure. In some embodiments, as part of the beam RSRP measurement, the apparatus 901 may measure one or more beams transmitted by the device 902 or a different device (e.g., millimeter wave (mmWave) base station).

In some embodiments, the apparatus 901 may perform the action 980 according to the received configuration information at step 970B, if the configuration information is sent by the device 902. For example, steps 970A and 970B are performed, and the action to be performed by the apparatus 901 is to transmit a beam measurement report to the device 902 according to the configuration information received at step 970B, and the apparatus 901 may transmit a beam measurement report to the device 902. In some embodiments, the apparatus 901 may know how to perform the configured action, for example based on a predetermined protocol, default signal configuration and/or initial event configuration. The apparatus 901 may send the measurement report to the device 902 by using a MAC-CE carried over physical uplink shared channel (PUSCH) or uplink control information (UCI) carried over PUSCH or physical uplink control channel (PUCCH).

The embodiments described above are in the context of UEs communicating with a base station or a TRP. However, more generally, apparatuses and/or devices that wirelessly communicate with each other over time-frequency resources need not necessarily be one or more UEs communicating with a TRP. For example, two or more UEs may wirelessly communicate with each other over a sidelink using device-to-device (D2D) communication. As another example, two network devices (e.g., a terrestrial base station and a non-terrestrial base station, such as a drone) may wirelessly communicate with each other over a backhaul link. Embodiments are not limited to uplink and/or downlink communication. For example, in the embodiments above, the base station may be substituted with another device, such as a node in the network or a UE. The uplink/downlink communication may instead be sidelink communication.

The embodiment of the present disclosure described above relate to beam measurements and reporting between a UE and a base station. The various methods described above and elsewhere in the present disclosure may be applied to various apparatuses and devices performing beam-based communications, such as those available in frequency division duplexing (FDD) or time division duplexing (TDD) systems. Although the embodiments described above are in the context of UEs communicating with a base station, a base station may determine or configure one or more conditions for a UE pertaining to how and when to report beam measurement transmitted from another UE in the context of sidelink communication.

Examples of apparatuses and devices (e.g. ED or UE and TRP or network device) to perform the various methods described herein are also disclosed.

For example, a (first) device may include a memory to store processor-executable instructions, and a processor to execute the processor-executable instructions. When the processor executes the processor-executable instructions, the processor may be caused to perform the method steps of one or more of the devices as described herein, e.g., in relation to FIG. 9. For example, the processor may cause the device to communicate over an air interface in a mode of operation by implementing operations consistent with that mode of operation, e.g. performing necessary measurements and generating content from those measurements, as configured for the mode of operation, preparing uplink transmissions and processing downlink transmissions, e.g., encoding, de-coding, etc., and configuring and/or instructing transmission/reception on RF chain(s) and antenna(s).

Note that the expression “at least one of A or B”, as used herein, is interchangeable with the ex-pression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

### DEFINITIONS OF ACRONYMS & GLOSSARIES

BS Base station
DFT
Discrete Fourier Transform
Downlink
DL
DMRS Demodulation reference signal
Frequency division duplexing FDD
HO Handover.
LOS Line of sight.
MAC-CE Medium (or media) access control-Control Element
NLOS Non-line of sight.
PDCCH Physical downlink control channel
PUCCH Physical uplink control channel
RF Radio frequency
RRC Radio resource control
RSRP Reference signal received power
RSRQ Reference signal received quality
Rx Receiver
SINR Signal to interference and noise ratio
SNR Signal to noise ratio
TDD Time division duplexing
TDMA Time division multiple access
Tx Transmitter
UCI Uplink control information
UE User equipment
UL Uplink

What is claimed is:

1. A method comprising:
receiving, by an apparatus from a device, event triggering information indicative of one or more conditions that when satisfied trigger the apparatus to perform an action;
obtaining, by the apparatus, sensing information related to the event triggering information;
determining, by the apparatus, whether the one or more conditions are satisfied based on the event triggering information and the sensing information; and
when the one or more conditions are satisfied, performing, by the apparatus, the action.

2. The method of claim 1, wherein the event triggering information is specific to the apparatus.

3. The method of claim 1, further comprising:
transmitting, by the apparatus to the device, information indicative of capability of the apparatus in relation to obtaining at least one of the sensing information or beam measurement information related to the event triggering information.

4. The method of claim 1, further comprising:
transmitting, by the apparatus to the device, an indication that the apparatus is going to perform the action; and
receiving, by the apparatus from the device, at least one of an acknowledgement message or configuration information related to performing the action.

5. The method of claim 1, wherein the event triggering information includes information indicative of at least one of:
a condition associated with a measured reference signal received power (RSRP) of a beam;
a condition based on the sensing information; or
a condition based on a change in the sensing information.

6. An apparatus comprising:
at least one processor; and
a computer-readable medium having stored thereon computer executable instructions that when executed cause the at least one processor to perform operations comprising:
receiving event triggering information indicative of one or more conditions that when satisfied trigger the apparatus to perform an action;
obtaining sensing information related to the event triggering information;
determining whether the one or more conditions are satisfied based on the event triggering information and the sensing information; and
when the one or more conditions are satisfied, performing the action.

7. The apparatus of claim 6, wherein the event triggering information is specific to the apparatus.

8. The apparatus of claim 6, wherein the computer executable instructions, when executed further cause the at least one processor to perform operations comprising:
transmitting information indicative of capability of the apparatus in relation to obtaining at least one of the sensing information or beam measurement information related to the event triggering information.

9. The apparatus of claim 6, wherein the computer executable instructions, when executed, further cause the at least one processor to perform operations comprising:
transmitting an indication that the apparatus is going to perform the action; and
receiving at least one of an acknowledgement message or configuration information related to performing the action.

10. The apparatus of claim 6, wherein the event triggering information includes information indicative of at least one of:
a condition associated with a measured reference signal received power (RSRP) of a beam;
a condition based on the sensing information; or
a condition based on a change in the sensing information.

11. A method comprising:
transmitting, by a device to an apparatus, event triggering information indicative of one or more conditions that when satisfied trigger the apparatus to perform an action;
wherein the action is performed by the apparatus when the one or more conditions are satisfied based on the event triggering information and sensing information related to the event triggering information.

12. The method of claim 11, further comprising:
determining, by the device, the event triggering information.

13. The method of claim 11, wherein the event triggering information is specific to the apparatus.

14. The method of claim 11, further comprising:
receiving, by the device from the apparatus, information indicative of capability of the apparatus in relation to obtaining at least one of the sensing information or beam measurement information related to the event triggering information.

15. The method of claim 11, further comprising:
receiving, by the device from the apparatus, an indication that the apparatus is going to perform the action; and
transmitting, by the device to the apparatus, at least one of an acknowledgement message or configuration information related to performing the action.

16. A device comprising:
at least one processor; and
a computer-readable medium having stored thereon computer executable instructions that when executed cause the at least one processor to perform operations comprising:
transmitting, to an apparatus, event triggering information indicative of one or more conditions that when satisfied trigger the apparatus to perform an action;
wherein the action is performed by the apparatus when the one or more conditions are satisfied based on the event triggering information and sensing information related to the event triggering information.

17. The device of claim 16, wherein the computer executable instructions, when executed further cause the at least one processor to perform operations comprising:
determining the event triggering information.

18. The device of claim 16, wherein the event triggering information is specific to the apparatus.

19. The device of claim 16, wherein the computer executable instructions, when executed further cause the at least one processor to perform operations comprising:
receiving information indicative of capability of the apparatus in relation to obtaining at least one of the sensing information or beam measurement information related to the event triggering information.

20. The device of claim 16, wherein the computer executable instructions, when executed further cause the at least one processor to perform operations comprising:
receiving an indication that the apparatus is going to perform the action; and
transmitting at least one of an acknowledgement message or configuration information related to performing the action.
